(19) United States
(12) Patent Application Publication
(10) Pub. No.: US 2025/0289330 A1
(43) Pub. Date: Sep. 18, 2025

(54) MOBILE VEHICLE CHARGING PROTECTION DEVICE FOR ELECTRICAL SAFETY IN LIVESTOCK HOUSES

(71) Applicant: Industrial Technology Research Institute, Hsinchu (TW)

(72) Inventors: Yen-Chia Peng, Hsinchu (TW); Ming-Tao Hu, Taichung City (TW); Wen-Ching Ko, Kaohsiung City (TW); Chien-An Tsai, Changhua County (TW); Shih-Chi Lee, Hsinchu City (TW); Wen-Lin Wang, Kaohsiung City (TW)

(73) Assignee: Industrial Technology Research Institute, Hsinchu (TW)

(21) Appl. No.: 18/779,039

(22) Filed: Jul. 21, 2024

(30) Foreign Application Priority Data
Mar. 14, 2024 (TW) 113109392

(51) Int. Cl. B60L 53/16

(52) U.S. Cl. CPC B60L 53/16

(57) ABSTRACT

A mobile vehicle charging protection device for electrical safety in livestock houses is disclosed, mainly uses the charging head to push against and connect the internal space of the charging tank body and the external space of a re-sealing door, such allows the charging head to enter a slot of the charging tank body, so that a first electrode interface provided on the plug connector of the charging head is connected with a second electrode interface provided on the slot to perform the charging operation, and after the charging is completed, the plug connector is re-covered with the sliding cover provided on the charging head and the slot is closed with the re-sealing door to prevent the first electrode interface and the second electrode interface from being contaminated by dirt in the livestock house environment, resulting in poor conductivity or short circuit or even leakage.

### CROSS-REFERENCE TO RELATED APPLICATION

The present application is based on, and claims priority from, Taiwan (International) application No. 113109392, filed on Mar. 14, 2024, the disclosure of which is hereby incorporated by reference herein in its entirety.

### TECHNICAL FIELD

The present disclosure belongs to the field of vehicle charging, and in particular, relates to a mobile vehicle charging protection device for electrical safety in livestock houses.

### BACKGROUND

Livestock houses are facilities for raising livestock. It takes a lot of labor to raise livestock, so in recent years, breeders have introduced automatic mobile vehicles to treat and put feed, clean livestock manure and push grass for feeding, thereby greatly reducing the demand for labor.

However, the general livestock house environment is muddy and waterlogged due to the mud or soil requirements of raising livestock, so the mobile vehicle has to work under a wet and dirty environment. In such an environment, when the mobile vehicle is charged, due to the charging structure of the mobile vehicle and the electrode may be exposed in a charging pile in some circumstances, the resistance value of the electrode of the mobile vehicle will be increased greatly, resulting in a decrease in the charging efficiency, even resulting in the corrosion of the electrode due to the contamination of the electrode, and even resulting in a shortcircuit situation. Such situations will lead to the damage to the mobile vehicle or the demand for regular maintenance, and will also lead to safety problems such as electrical leakage in muddy and waterlogged environments.

In addition, for example, in an application, a fully-covered discharge station body is disclosed, but it also additionally add a power device, a control module, an electrical module and other equipment, so that the overall required cost is increased, and the failure probability is also increased, thereby being not suitable for being used on the mobile vehicle for livestock houses.

### SUMMARY

The mobile vehicle charging protection device for electrical safety in livestock houses provided by the present disclosure mainly includes: a charging head and a charging tank body. The charging head includes: a sliding cover, a plug connector and at least one displacement re-setting device. The charging tank body includes a slot, at least re-sealing door and at least one sliding cover restriction beam.

The sliding cover is internally provided with a placement slot, a peripheral wall surface of the placement slot is provided with at least one sliding slot, one end of the sliding cover is provided with an inlet/outlet, and the inlet/outlet communicates with the placement slot.

The plug connector is arranged in the placement slot, at least one first electrode interface is arranged on at least one surface of a peripheral edge of one end of the plug connector in the direction of the peripheral edge of the plug connector is provided inlet/outlet direction, and the peripheral edge of the plug connector is provided with at least one sliding rail corresponding to the sliding slot.

At least one second electrode interface is arranged on at least one inner side wall surface of the slot, and one end of the slot is provided with a socket communicating with the internal space of the slot and the external space of the slot.

### BRIEF DESCRIPTION OF THE DRAWINGS

FIG. 1 is a three-dimensional external view of a charging head of a mobile vehicle charging protection device for electrical safety in livestock houses according to the present disclosure;

FIG. 2 is a three-dimensional external view of a charging tank body of a mobile vehicle charging protection device for electrical safety in livestock houses according to the present disclosure;

FIG. 3 is a first action structural schematic of a mobile vehicle charging protection device for electrical safety in livestock houses according to the present disclosure;

FIG. 4 is a second action structural schematic of a mobile vehicle charging protection device for electrical safety in livestock houses according to the present disclosure; and

FIG. 5 is a third action structural schematic of a mobile vehicle charging protection device for electrical safety in livestock houses according to the present disclosure.

### DESCRIPTION OF SIGNS OF MAIN COMPONENTS

1: charging head
11: plug connector
111: first electrode interface
112: sliding rail
1121: front end face
12: sliding cover
121: placement slot
122: sliding slot
1221: wall surface
13: inlet/outlet
14: displacement re-setting device
2: charging tank body
21: socket
22: slot
221: second electrode interface
222: side edge wall surface
23: sliding cover restriction beam
24: re-scaling door
241: shaft rod
242: door body

### DETAILED DESCRIPTION

In order to facilitate understanding of the examination committee for the technical features, contents and advantages of the present disclosure and the effects achieved thereby, the present disclosure will be described in details with reference to the accompanying drawings and attachments by means of the embodiments. The drawings used therein are only intended to illustrate and assist the specification, and may not be the true scale and precise configuration of the present disclosure after implementation. Therefore, the scale and configuration relationship of the accompanying drawings should not be interpreted to limit the scope of the claims.

In the description of this implementation, it is to be understood that the orientations or positional relationship of the terms “top”, “bottom”, “left”, “right”, “top”, “bottom”, “inside”, “outside”, etc. indicate orientations or positional relationships that are based on the accompanying drawings, are intended only to illustrate and simplify the description of the disclosure, and not to indicate or imply that a device or an element referred to have a particular orientation and be constructed and operated in a particular orientation, and therefore shall not be construed as limiting the present disclosure.

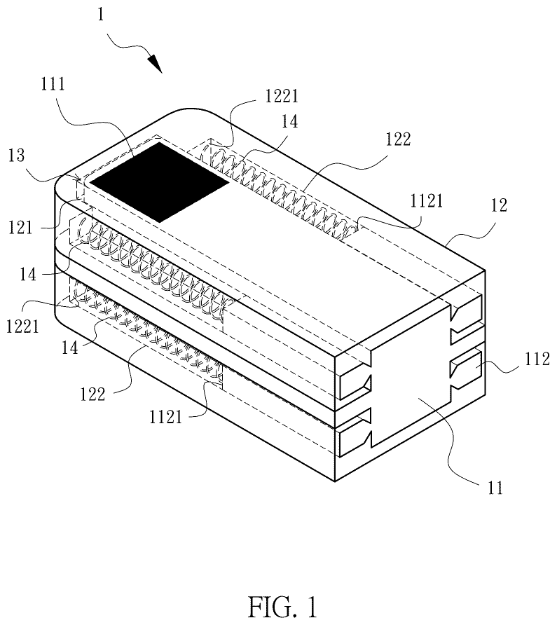

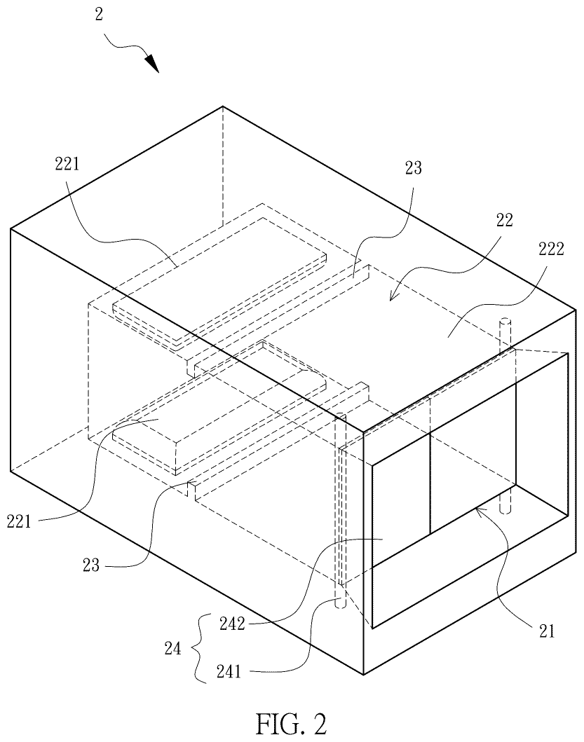

Referring to FIG. 1 to FIG. 2, the mobile vehicle charging protection device for electrical safety in livestock houses provided by the present disclosure mainly includes a charging head 1 and a charging tank body 2; the charging head 1 includes a plug connector 11 and a sliding cover 12; a first electrode interface 111 is arranged on a peripheral surface of a front end of the plug connector 11; sliding rails 112 are arranged at the rear ends of two sides of the plug connector 11; the sliding cover 12 is internally provided with a placement groove 121; sliding slots 122 are formed in inner edge wall surfaces of two sides of the placement slot 121; a front end of the sliding cover 12 is provided with an inlet/outlet 13 to communicate the external space of the sliding cover 12 and the placement slot 121; the plug connector 11 is arranged in the placement slot 121; and the sliding rails 112 on two sides of the plug connector 11 are arranged in the sliding slots 122 at two sides of the placement slot 121. In addition, a displacement re-setting device 13 is arranged between the plug connector 11 and the sliding cover 12, the displacement re-setting device 13 is a compression spring, a rear end of the displacement re-setting device 13 abuts against a front end face 1121 of the sliding rail 112 facing the direction of the inlet/outlet 13, and a front end of the displacement re-setting device 14 abuts against a wall surface 1221 of the sliding slot 122 at the peripheral edge of the inlet/outlet 13 facing the interior of the sliding slot 122.

In the mobile vehicle charging protection device for electrical safety in livestock houses provided by the present disclosure, one end of the charging tank body 2 is provided with a socket 21 to communicate the slot 22 inside the charging tank body 2; a second electrode interface 221 corresponding to the first electrode interface 111 of the plug connector 11 is arranged on the inner side wall surface of the slot 22; and the inner side wall surface in the slot 22 between the second electrode interface 221 and the socket 21 is convexly provided with at least one sliding cover restriction beam 23. In addition, the slot 22 is provided with a re-sealing door 24 at the position of the socket 21; the re-sealing door 24 includes a shaft rod 241 and a door body 242 extending to one side of the shaft rod 241; and upper and lower ends of the shaft rod 241 penetrate through upper and lower ends of the socket 21 close to a side edge wall surface 222 of the slot 22. In addition, a push re-setting device (not shown in the figure) is arranged on the shaft rod 241 of the re-sealing door 24, the push re-setting device is a torsion spring, and two torsion arms of the torsion spring respectively abut against the door body 242 and the side edge wall surface 222 of the slot 22.

In the mobile vehicle charging protection device for electrical safety in livestock houses provided by the present disclosure, the charging head 1 and the charging tank body 2 are respectively arranged on the mobile vehicle and a charging pile of the livestock house. For example, the charging head 1 is arranged on the mobile vehicle to serve as a charging interface, and the charging tank body 2 is arranged on the charging pile to serve as a power supply interface; or the charging tank body 2 is arranged on the mobile vehicle to serve as a charging interface, and the charging head 1 is arranged on the charging pile to serve as a power supply interface. The first electrode interface 111 and the second electrode interface 221 are respectively a charging electrode and a discharging electrode. For example, the first electrode interface 111 is a charging electrode when the charging head 1 is arranged on the mobile vehicle, and the first electrode interface 111 is a discharging electrode when the charging head 1 is arranged on the charging pile; and on the contrary, the second electrode interface 221 is a discharging electrode when the charging tank body 2 is arranged on the charging pile, and the second electrode interface 221 is a charging electrode when the charging tank body 2 is arranged on the mobile vehicle.

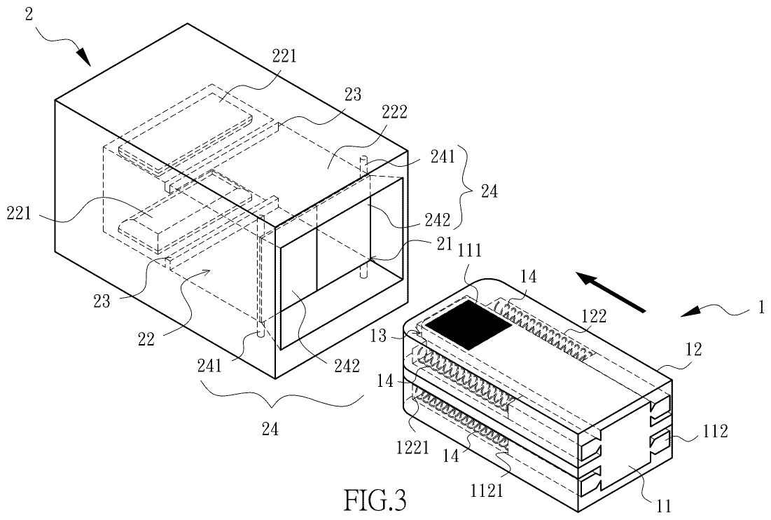

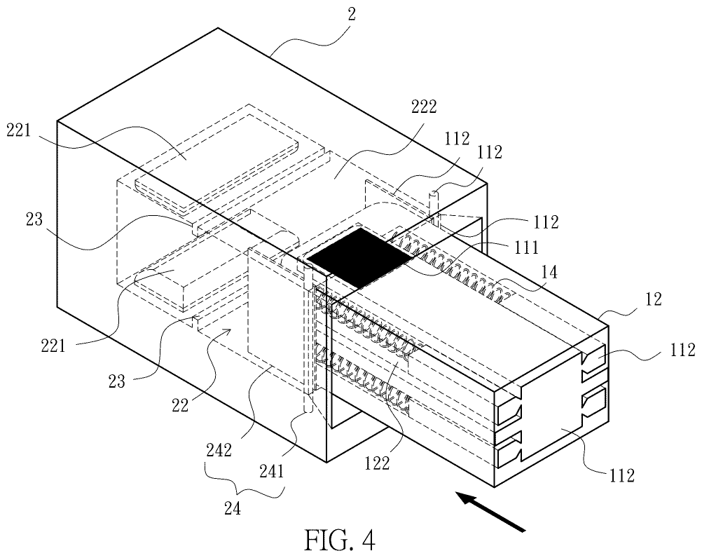

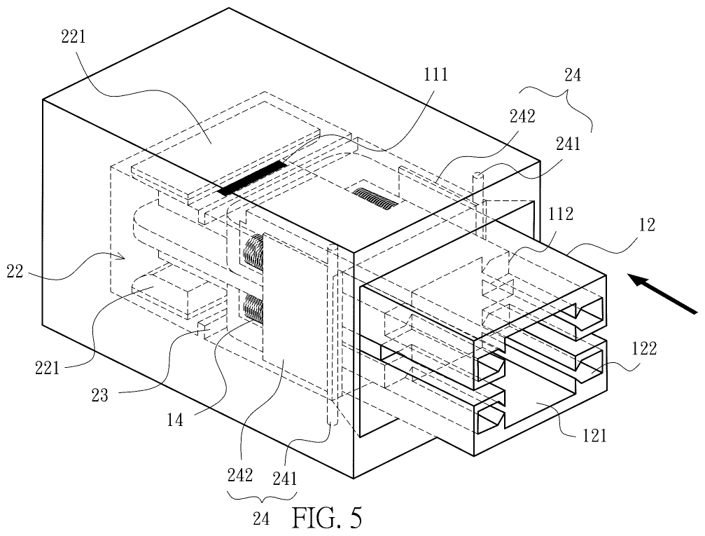

Referring to FIG. 1 to FIG. 5, in this embodiment, the charging head 1 is arranged on the mobile vehicle to serve as a charging interface, and the charging tank body 2 is arranged on the charging pile to serve as a power supply interface. Therefore, when the mobile vehicle charging protection device for electrical safety in livestock houses provided by the present disclosure is desired to perform charging operation, the mobile vehicle is close to the charging pile and the charging head 1 faces the direction of the discharging tank body 2. At this time, the mobile vehicle continuously moves towards the direction of the discharging tank body 2, so that the charging head 1 abuts against the door body 242 of the re-sealing door 24 of the discharging tank body 2, and the door body 242 of the re-sealing door 24 rotates by taking the shaft rod 241 as an axis. Meanwhile, the push re-setting device is compressed to open the re-sealing door 24, so that the charging head 1 enters the slot 22.

When charging is completed and the mobile vehicle drives the charging head 1 to be withdrawn from the charging tank body 2, the charging head is pushed by the elastic force of the displacement re-setting device 14, so that the plug connector 11 re-enters the sliding cover 12 through the sliding rail 112 along the sliding slot 122, the sliding cover 12 covers the first electrode interface 112, and the first electrode interface 112 is not exposed outside, thereby preventing the first electrode interface 112 from being polluted by aqueous vapor and dirt in the outside environment. Meanwhile, when the charging head 1 is withdrawn from the charging tank body 2, the re-sealing door 24 which the socket 21 of the charging tank body 2 is provided with is pushed by the elastic force of the torsion arm of the push re-setting device, so that the door body 242 of the re-sealing door 24 is pushed to rotate the shaft rod 241, thereby re-sealing the socket 21, isolating the internal space of the slot 22 and the external space of the charging tank body 2 by the re-sealing door 24, and preventing the second electrode interface 221 from being polluted by aqueous vapor and dirt in the outside environment.

The mobile vehicle charging protection device for electrical safety in livestock houses provided by the present disclosure is mainly as follows: the charging head and the charging tank body are respectively arranged on the mobile vehicle and the charging pile of the livestock house so as to push against and open the re-sealing door of the charging tank body by the charging head when the mobile vehicle performs charging operation, the slot is entered, the sliding cover restriction beam abuts against the sliding cover, so that the plug connector of the charging head passes through the inlet/outlet of the sliding cover, the first electrode interface on the plug connector is exposed and abutted with the second electrode interface in the slot to perform the charging operation; after charging is completed and when the charging head is withdrawn from the charging tank body, the charging head uses the displacement re-setting device to push back the sliding cover and cover the first electrode interface; and the charging tank body uses the push re-setting device to push back the re-sealing door to re-seal the socket of the slot, thereby preventing the second electrode interface from being exposed outside.

In conclusion, according to the mobile vehicle charging protection device for electrical safety in livestock houses provided by the present disclosure, through the design of the sliding cover and the re-sealing door, the first electrode interface and the second electrode interface are exposed only when the mobile vehicle performs the charging operation; and when the mobile vehicle performs other services or is standby, the first electrode interface and the second electrode interface are not exposed in the outside environment, thereby effectively preventing the moisture of the air in the livestock house and the dirt in the environment from eroding the first electrode interface and the second electrode interface, and preventing the first electrode interface and the second electrode interface from being corroded or causing shortcircuit or electrical leakage.

In conclusion, according to the mobile vehicle charging protection device for electrical safety in livestock houses provided by the present disclosure, when the mobile vehicle and the charging pile do not perform the charging operation, through the arrangement of the sliding cover and the re-sealing door, the first electrode interface and the second electrode interface are not exposed in the outside environment, thereby avoiding the reduced charging efficiency caused by the influence of the previous technology by the water vapor in the outside environment, and preventing the electrode from being contaminated by dirt and corroded and causing shortcircuit, even electrical leakage.

The above indicates only some embodiments of the present disclosure but are not intended to limit the scope of the present disclosure, a person skilled in the art shall know that several variants and improvements may be made, which all are all within the protection scope of the present disclosure.

What is claimed is:

1. A mobile vehicle charging protection device for electrical safety in livestock houses, mainly comprising:
a charging head, comprising:
a sliding cover, one end of the sliding cover being provided with an inlet/outlet communicating with a placement slot in the sliding cover,
a plug connector, arranged in the placement slot, at least one surface of a peripheral edge of one end of the plug connector facing the direction of the inlet/outlet being provided with at least one first electrode interface, and
at least one displacement re-setting device, arranged inside the sliding cover and connected to the plug connector; and
a charging tank body, internally provided with at least one second electrode interface,
wherein the charging head is butted with the charging tank body; when the charging head enters the charging tank body, one end of the plug connector provided with the first electrode interface passes through the sliding cover from the inlet/outlet along the placement slot, so that the first electrode interface is in contact with the second electrode interface after being exposed to perform a charging operation; and when charging ends and the charging head is withdrawn from the charging tank body, the plug connector is pushed into the placement slot by the displacement re-setting device.

2. The mobile vehicle charging protection device for electrical safety in livestock houses according to claim 1, wherein the first electrode interface is a charging electrode, and the second electrode interface is a discharging electrode.

3. The mobile vehicle charging protection device for electrical safety in livestock houses according to claim 1, wherein the first electrode interface is a discharging electrode, and the second electrode interface is a charging electrode.

4. The mobile vehicle charging protection device for electrical safety in livestock houses according to claim 1, wherein the displacement re-setting device is a compression spring or a mechanism type reset structure.

5. The mobile vehicle charging protection device for electrical safety in livestock houses according to claim 1, wherein the sliding cover is internally provided with the placement slot, a peripheral wall surface of the placement slot is provided with at least one sliding slot, the periphery edge of the plug connector is provided with at least one sliding rail corresponding to the sliding slot, and the displacement re-setting device is arranged between a surface of the sliding rail facing the direction of the inlet/outlet and a wall surface of the placement slot located on the peripheral edge of the inlet/outlet.

6. A mobile vehicle charging protection device for electrical safety in livestock houses, mainly comprising:
a charging head, provided with at least one first electrode interface; and
a charging tank body, comprising:
a slot, a wall surface of at least one inner side of the slot being provided with at least one second electrode interface, and one end of the slot being provided with a socket communicating with an exterior of the slot, and
at least one re-sealing door, arranged at the position of the socket and configured to seal the slot, one end of a wall surface of an inner side of the re-sealing door adjacent to the slot being connected to the slot through at least one push re-setting device,
wherein the charging head is butted with the charging tank body; when the charging head enters the charging tank body, the re-sealing door is pushed by the charging head and pushed into the slot at the other end opposite to the push re-setting device to turn on the socket, so that the second electrode interface is exposed and is in contact with the first electrode interface to perform charging operation; and when charging ends and the charging head is withdrawn from the slot, the re-sealing door is pushed by the push re-setting device to re-seal the socket.

7. The mobile vehicle charging protection device for electrical safety in livestock houses according to claim 6, wherein the first electrode interface is a charging electrode, and the second electrode interface is a discharging electrode.

8. The mobile vehicle charging protection device for electrical safety in livestock houses according to claim 6, wherein the first electrode interface is a discharging electrode, and the second electrode interface is a charging electrode.

9. The mobile vehicle charging protection device for electrical safety in livestock houses according to claim 6, wherein the re-sealing door at least comprises a shaft part, a door body and at least one push re-setting device; two ends of the shaft part respectively penetrate through the position of the socket adjacent to one inner side wall of the slot; one end of the door body is connected to the shaft part; and the push re-setting device is arranged on the shaft part.

10. The mobile vehicle charging protection device for electrical safety in livestock houses according to claim 6, wherein the push re-setting device is a torsion spring or other mechanism type reset structures.

11. A mobile vehicle charging protection device for electrical safety in livestock houses, mainly comprising:
a charging head, comprising:
a sliding cover, one end of the sliding cover being provided with an inlet/outlet communicating with a placement slot in the sliding cover,
a plug connector, arranged in the placement slot, at least one surface of a periphery of one end of the plug connector facing the direction of the inlet/outlet being provided with at least one first electrode interface, and
at least one displacement re-setting device, arranged inside the sliding cover and connected to the plug connector; and
a charging tank body, comprising:
a slot, a wall surface of at least one inner side of the slot being provided with at least one second electrode interface, and one end of the slot being provided with a socket communicating with an exterior of the slot,
at least one re-sealing door, arranged at the position of the socket and configured to seal the slot, one end of a wall surface of an inner side of the re-sealing door adjacent to the slot being connected to the slot through at least one push re-setting device, and
at least one sliding cover restriction beam, arranged between the second electrode interface inside the slot and at least one inner side wall surface of the re-sealing door,
wherein when the charging head abuts against and open the re-sealing door to enter the slot, the sliding cover is resisted by the sliding cover restriction beam to make the plug connector pass through the inlet/outlet, so that the first electrode interface is exposed to be in contact with the second electrode interface to perform the charging operation; and when the charging head is withdrawn from the slot and after the sliding cover is withdrawn from the sliding cover restriction beam, the plug connector is pushed and reset into the placement slot by the displacement re-setting device, and the re-sealing door is pushed by the push re-setting device to re-seal the socket.

12. The mobile vehicle charging protection device for electrical safety in livestock houses according to claim 11, wherein the first electrode interface is a charging electrode, and the second electrode interface is a discharging electrode.

13. The mobile vehicle charging protection device for electrical safety in livestock houses according to claim 11, wherein the first electrode interface is a discharging electrode, and the second electrode interface is a charging electrode.

14. The mobile vehicle charging protection device for electrical safety in livestock houses according to claim 11, wherein the displacement re-setting device is a compression spring or a mechanism type reset structure.

15. The mobile vehicle charging protection device for electrical safety in livestock houses according to claim 11, wherein the re-sealing door at least comprises a shaft part, a door body and at least one push re-setting device; two ends of the shaft part respectively penetrate through the position of the socket adjacent to one inner side wall of the slot; one end of the door body is connected to the shaft part; and the push re-setting device is arranged on the shaft part.

16. The mobile vehicle charging protection device for electrical safety in livestock houses according to claim 11, wherein the sliding cover is internally provided with the placement slot, a peripheral wall surface of the placement slot is provided with at least one sliding slot, the periphery of the plug connector is provided with at least one sliding rail corresponding to the sliding slot, and the displacement re-setting device is arranged between a front end face of the sliding rail facing the direction of the inlet/outlet and a wall surface of the sliding slot located on the peripheral edge of the inlet/outlet facing an interior of the sliding slot.

17. The mobile vehicle charging protection device for electrical safety in livestock houses according to claim 15, wherein the push re-setting device is a torsion spring or other mechanism type reset structures.
